(19) United States
(12) Patent Application Publication
(10) Pub. No.: US 2018/0113496 A1
(43) Pub. Date: Apr. 26, 2018

(54) DYNAMICALLY CHANGING A POWER SUPPLY VOLTAGE TO A SYSTEM

(71) Applicant: Hewlett Packard Enterprise Development LP, Houston, TX (US)

(72) Inventors: David F. Heinrich, Tomball, TX (US); Hung Quoc Phu, Houston, TX (US); David W. Engler, Cypress, TX (US)

(21) Appl. No.: 15/567,621

(22) PCT Filed: May 15, 2015
(86) PCT No.: PCT/US2015/031256

§ 371 Date: Nov. 1, 2017

(51) Int. Cl. G06F 1/26; G06F 1/32; G06F 1/28

(52) U.S. Cl. CPC G06F 1/263; G06F 1/3206; G06F 1/3287; G06F 1/28; G06F 1/3296

(57) ABSTRACT

Example implementations relate to dynamically changing a power voltage to a system. For example, a system includes a power supply unit to provide power to the system and a control module. The control module is to dynamically enable a first output voltage level from the power supply unit to the system when the system is operating in a first mode, and to dynamically enable a second output voltage level from the power supply unit to the system when the system is operating in a second mode. The first output voltage level is greater than the second output voltage level.

### BACKGROUND

A power supply unit (PSU) converts mains alternating current (AC) power to low-voltage regulated direct current (DC) power for components or loads of a system (e.g., a server computing device). A server can receive a 12V output voltage from a PSU and use the 12V to power lower voltage regulators for the server components/loads including 3.3V, 5V, or 6V, for example.

### BRIEF DESCRIPTION OF THE DRAWINGS

Some examples of the present application are described with respect to the following figures:

FIG. 1 is a block diagram of an example system including a control module for dynamically changing a power supply voltage to the system;

FIG. 2 is a flowchart of an example method for dynamically changing a power supply voltage to a system;

FIG. 3 is a flowchart of another example method for dynamically changing a power supply voltage to a system; and

FIG. 4 is a block diagram of a computer-readable storage medium having instructions executable to dynamically change a power supply voltage to a system.

### DETAILED DESCRIPTION

Examples disclosed herein relate to dynamically changing the power supply voltage to a system (e.g., a server system) to improve power efficiency and reduce overall power consumption. The described solution can be enabled during low utilization periods to save power, or enabled continuously. By utilizing a lower voltage instead of a static 12V power provided by a power supply unit, the efficiency of the server can be significantly increased. For example, dynamically changing to a lower voltage (e.g., 6V, 5V, 3.3V, etc.) can significantly reduce power consumption of the server at run time compared to a static voltage of 12V. The described examples further enable a switch to the higher voltage (e.g., 12V) level when the server switches from the low power mode to a high power mode.

In one example, a system includes a power supply unit to provide power to the system and a control module. The control module is to dynamically enable a first output voltage level from the power supply unit to the system when the system is operating in a first mode, and to dynamically enable a second output voltage level from the power supply unit to the system when the system is operating in a second mode. The first output voltage level is greater than the second output voltage level.

In another example, a method includes determining, by a control module, a power consumption of a system and dynamically changing an output voltage provided to the system by a power supply unit based on the power consumption. Dynamically changing the output voltage to the system includes switching to a first output voltage when the system is operating in a first power state and switching to a second output voltage when the system is operating in a second power state, where the first output voltage is higher than the second output voltage.

In another example, a non-transitory computer-readable storage medium is encoded with instructions executable by a processor of a system to determine a power consumption of the system and dynamically change an output voltage provided to the system by a power supply unit based on the power consumption of the system. The instructions are executable to switch to a first output voltage when the system is operating in a first power state and switch to a second output voltage when the system is operating in a second power state, where the first output voltage is greater than the second output voltage.

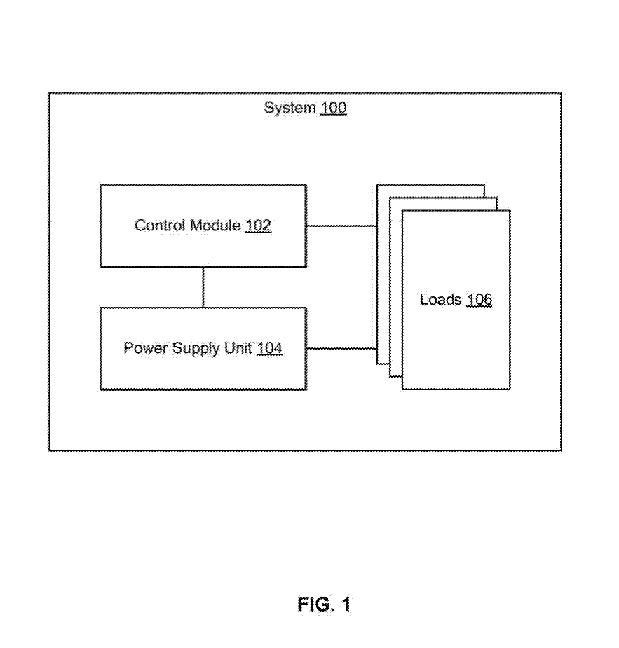

Referring now to the figures, FIG. 1 is a block diagram of an example system including a control module for dynamically changing a power supply voltage to the system. System 100 can be any type of computing system such as a portable computer or communication device, a standalone server computer, a blade server, etc. System 100 can include a control module 102, a power supply unit 104, and a plurality of loads 106. System 100 can include additional components other than those shown in FIG. 1 such as embedded firmware and hardware components. For example, system 100 can include a central processing unit (CPU), display, other hardware, software application, a plurality of input/output (I/O) ports, etc.

Control module 102 can include one or more CPUs or cores thereof, microprocessors, hardware state machines, graphic processing units (GPUs), field-programmable gate arrays (FGPAs), or other electronic circuitry, which may be integrated in a single device or distributed across devices. In some examples, control module 102 may include one or more “lights-out” modules that may be powered on and operational when other modules or components of the system 100 are not powered on or are not operational. Control module 102 can be responsible for managing some or all of the functionalities of the system 100, including dynamically changing the power supply voltage to the system 100.

Power supply unit 104 can be a device capable of providing electrical energy to a load, such as the plurality of loads 106 of the system 100, by converting electrical energy from one form to another to make the energy compatible with the load's requirement. For example, power supply unit 104 can provide power to the loads 106 by converting an alternating current (AC) energy to a lower-voltage, regulated direct current (DC) energy for use by the loads 106 of the system 100. Thus, power supply unit 104 can provide an output voltage to power the loads 106. In some examples, the power supply unit 104 can be internal to the system 100, as shown in FIG. 1. In other examples, power supply unit 104 can be external to the system 100. Loads 106 include a CPU, memory, I/O devices, a GPU, or any other components and/or devices of the system 100.

During operation of the system 100 (e.g., during run-time), control module 102 can dynamically change the output voltage level to the system 100 to improve power efficiency and reduce the power consumption of the system 100. Control module 102 can enable a first output voltage level to the system 100 when the system 100 is operating in a first mode and enable a second output voltage level to the system 100 when the system 100 is operating in a second mode, where the first output voltage level is greater than the second output voltage level. For example, the control module 102 can enable a high output voltage such as a 12V output voltage, from the power supply unit 104, to the system 100 when the system 100 is operating in a high power state (e.g., a full operational mode) and enable a lower output voltage (e.g., 3.3V, 5V, 6V), from the power supply unit 104, to the system 100 when the system 100 is operating in a low power state (e.g., idle mode, sleep mode, etc.). It should be noted that in various examples, the high output voltage is not limited to 12V and can be any voltage level. In any case, the lower output voltage is lower than the high output voltage.

The determination to enable the first output voltage level and the second output voltage level can be based on the power consumption of the system 100. For example, the control module 102 can measure the power consumption of the system 100 and enable the first or second output voltage level based on the power consumption of the system 100. The power consumption of the system 100 can be based on a total power consumption of the plurality of loads 106 (i.e., the sum of the power consumption of each of the loads 106). In certain examples, the control module 102 can measure the instantaneous power level of each of the loads 106. In such examples, control module 102 can include a power monitor to measure the power consumption of the loads, where the power monitor can be implemented as an e-fuse, for example, or any other software and/or hardware circuitry.

Control module 102 can dynamically switch between the first output voltage level and the second output voltage level based on the power consumption of the system 100. For example, if the power consumption of the system 100 is below a pre-defined level for a period of time, control module 102 can dynamically switch the power supply output voltage level to the second output voltage level (i.e., a lower voltage) to increase the power efficiency of the system 100. To prevent a potential oversubscription of power due to a sudden uptick in power consumption by the system 100, the control module 102 can implement throttling to allow the power supply output voltage time to increase. Once the voltage level has been increased, throttling can be turned off and the system 100 can perform at a high efficiency rate. For example, the CPU or any other load 106 can be throttled when switching from the low output voltage level (i.e., less than 12V) to the high output voltage level (e.g., 12V) and turning off the throttling when the high output voltage level has been reached. Throttling is implemented to maintain or reduce power consumption of the system 100 to a level that the lower voltage level can sustain the system 100 until the higher voltage level is reached. By dynamically changing the power supply output voltage to the system 100, a significant power efficiency of the system 100 can be achieved, as the overall system power is reduced.

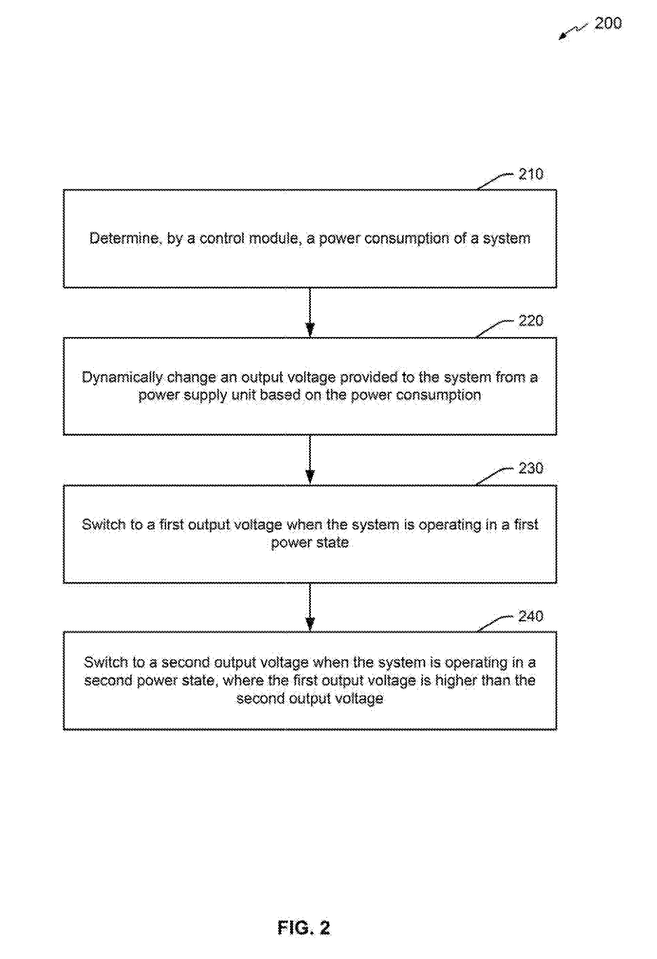

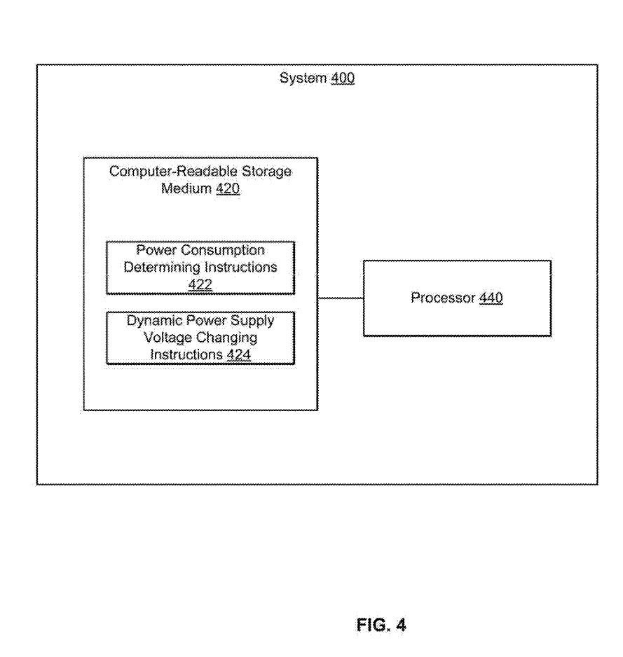

FIG. 2 is a flowchart of an example method for dynamically changing a power supply voltage to a system. Although execution of method 200 is described below with reference to system 100 of FIG. 1, other suitable devices for execution of method 200 can be used. Method 200 can be implemented in the form of executable instructions stored on a computer-readable storage medium, such as computer-readable storage medium 420 of FIG. 4, and/or in the form of electronic circuitry.

Method 200 includes determining, by a control module, a power consumption of a system, at 210. For example, control module 102 can measure the power consumption of the plurality of loads 106 to determine the power consumption of the system 100. In some examples, the power consumption of the system 100 can vary based on the operational mode (e.g., idle, sleep, power on, etc.) of the system 100. Thus, control module can measure an instantaneous power consumption or power level of the system 100.

Method 200 includes dynamically changing an output voltage provided to the system by a power supply unit based on the power consumption, at 220. For example, control module 102 can dynamically change the power supply output voltage to the system 100 based on the power consumption of the system 100. The power consumption of the system 100 can be a total power consumption of the loads 106.

Method 200 includes switching to a first output voltage when the system is operating in a first power state, at 230, and switching to a second output voltage when the system is operating in a second power state, at 240 where the first output voltage is higher than the second output voltage. For example, control module 102 can dynamical switch between a high power supply output voltage of 12V and a low power supply output voltage lower than 12V (e.g., 3.3V, 5V, 7V, etc.) based on whether the system 100 is operating in a high power state and a low power state, respectively. In some examples, the method 200 of FIG. 2 includes additional steps in addition to and/or in lieu of those depicted in FIG. 2.

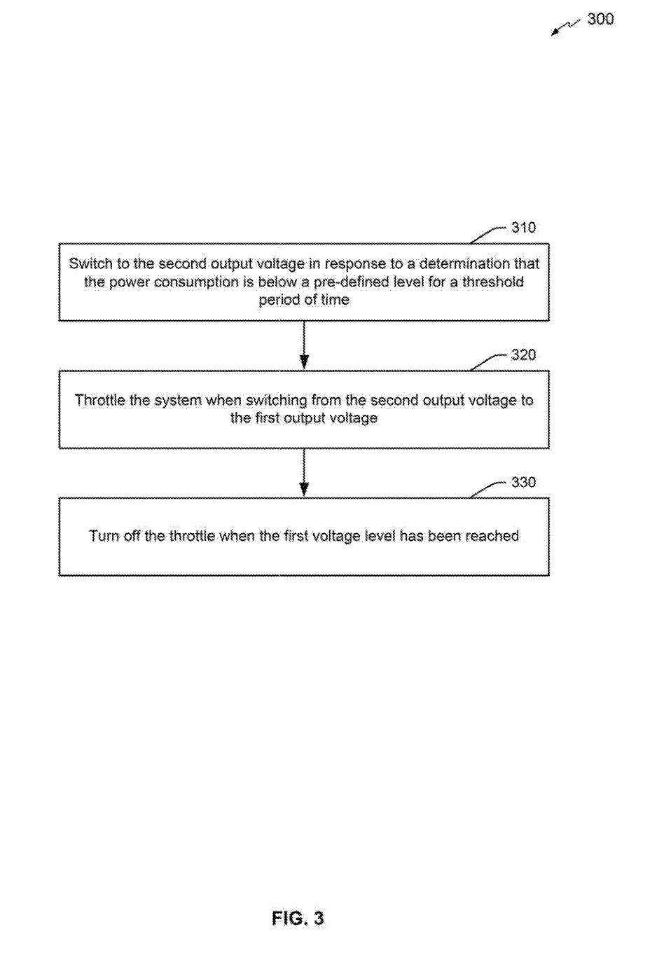

FIG. 3 is a flowchart of another example method for dynamically changing a power supply voltage to a system. Although execution of method 300 is described below with reference to device 100 of FIG. 1, other suitable devices for execution of method 300 may be used. Method 300 can be implemented in the form of executable instructions stored on a computer-readable storage medium, such as computer-readable storage medium 420 of FIG. 4, and/or in the form of electronic circuitry.

Method 300 includes switching to the second output voltage in response to a determination that the power consumption is below a pre-defined level for a threshold period of time, at 310. For example, control module 102 can dynamically switch to the low power supply output voltage upon determining that the power consumption of the system 100 is below a pre-defined level for a threshold period of time. The pre-defined level can indicate that the system 100 is operating in a low power mode.

Method 300 includes throttling the system when switching from the second output voltage to the first output voltage, at 320. For example, control module 102 can throttle at least one load (e.g., the CPU, GPU, memory, I/O device, etc.) when switching from the low power supply output voltage to the high power supply output voltage.

Method 300 includes turning off the throttle when the first output voltage level has been reached, at 330. For example, control module 102 can turn off the throttle when the high power supply output voltage has been reached. In some examples, the method 300 of FIG. 3 includes additional steps in addition to and/or in lieu of those depicted in FIG. 3.

FIG. 4 is a block diagram of a computer-readable storage medium having instructions executable to dynamically change a power supply voltage to a system. System 400 can be similar to the system 100 of FIG. 1. System 400 includes a processor 440 and a computer-readable storage medium 420.

Processor 440 can be one or more central processing units (CPUs), microprocessors, and/or other hardware devices suitable for retrieval and execution of instructions stored in computer-readable storage medium 420. Processor 440 may fetch, decode, and execute instructions 422 and 424 to dynamically change a power supply voltage to the system 400, as described below. As an alternative or in addition to retrieving and executing instructions, processor 440 may include one or more electronic circuits comprising a number of electronic components for performing the functionality of one or more of instructions 422 and 424.

Computer-readable storage medium 420 may be any electronic, magnetic, optical, or other physical storage device that stores executable instructions. Thus, computer-readable storage medium 420 may be, for example, random access memory (RAM), content addressable memory (CAM), ternary content addressable memory (TCAM), an electrically-erasable programmable read-only memory (EEPROM), flash memory, a storage drive, an optical disc, and the like. As described in detail below, computer-readable storage medium 420 may be encoded with executable instructions for dynamically changing a power supply voltage to the system 400.

Power consumption determining instructions 422 include instructions to determine a power consumption of the system. For example, the power consumption of the system 400 can be based on a total power consumption of a plurality of loads of the system 400. In some examples, the power consumption of the system 400 can be determined based on an instantaneous power consumption of the system 400.

Dynamic power supply voltage changing instructions 424 include instructions to dynamically change an output voltage provided to the system by a power supply unit based on the power consumption of the system. The instructions 424 are executable to switch to a first output voltage when the system is operating in a first power state and switch to a second output voltage when the system is operating in a second power state, where the first output voltage is greater than the second output voltage. The instructions 424 are executable to switch to the second output voltage when the power consumption of the system is below a threshold value for a pre-defined period of time. The instructions 424 are further executable to throttle at least one load of the system as the output voltage transitions to the first output voltage and to disable the throttle when the first output voltage has been reached.

The techniques described above may be embodied in a computer-readable medium for configuring a computing system to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and obvious types of computer-readable media may be used to store the software modules discussed herein. Computing systems may be found in many forms including but not limited to mainframes, minicomputers, servers, workstations, personal computers, notepads, personal digital assistants, tablets, smartphones, various wireless devices and embedded systems, just to name a few.

What is claimed is:

1. A system, comprising:
a power supply unit to provide power to the system; and
a control module to dynamically:
enable a first output voltage level from the power supply unit to the system when the system is operating in a first mode; and
enable a second output voltage level from the power supply unit to the system when the system is operating in a second mode,
wherein the first output voltage level is greater than the second output voltage level.

2. The system of claim 1, wherein the control module is to dynamically switch between the first output voltage level and the second output voltage level, during run time of the system, based on an operation mode of the system, wherein the operation mode includes the first mode and the second mode.

3. The system of claim 1, wherein the controller is to:
measure a power consumption of the system; and
enable the first and second output voltage levels based on the measured power consumption of the system,
wherein the power consumption of the system is based on a total power consumption of a plurality of loads of the system.

4. The system of claim 3, wherein the controller is to enable the second output voltage level when the power consumption of the system is below a pre-defined level for a period of time.

5. The system of claim 3, wherein the controller is to throttle at least one load of the plurality of loads when switching to the first output voltage level.

6. The system of claim 1, wherein the first mode is a high power state of the system and the wherein the second mode is a low power state of the system.

7. The system of claim 1, wherein the first output voltage level is 12V and wherein the second output voltage level is less than 12V.

8. The system of claim 1, wherein the control module is to measure an instantaneous power consumption of the system based on a plurality of loads of the system and wherein the plurality of loads include at least one of a central processing unit (CPU), a graphical processing unit (GPU), memory, and an input/output (I/O) device.

9. A method, comprising:
determining, by a control module, a power consumption of a system; and
dynamically changing an output voltage provided to the system by a power supply unit based on the power consumption, wherein dynamically changing the output voltage to the system includes:
switching to a first output voltage when the system is operating in a first power state; and
switching to a second output voltage when the system is operating in a second power state,
wherein the first output voltage is higher than the second output voltage.

10. The method of claim 9, comprising switching to the second output voltage in response to determining that the power consumption is below a pre-defined level for a threshold period of time.

11. The method of claim 9, comprising:
throttling the system when switching from the second output voltage to the first output voltage;
turning off the throttling when the first voltage level has been reached.

12. The method of claim 1, wherein the first power state is a high power state and wherein the second power state is a low power state, and wherein the first output voltage is 12V and wherein the second output voltage is less than 12V.

13. A non-transitory computer-readable storage medium encoded with instructions executable by a processor of a system, the computer-readable storage medium comprising instructions to:
determine a power consumption of the system; and
dynamically change an output voltage provided to the system from a power supply unit based on the power consumption of the system, wherein the instructions are to:
switch to a first output voltage when the system is operating in a first power state; and
switch to a second output voltage when the system is operating in a second power state,
wherein the first output voltage is greater than the second output voltage.

14. The non-transitory computer-readable storage medium of claim 13, comprising instructions to switch to the second output voltage when the power consumption of the system is below a threshold value for a pre-defined period of time.

15. The non-transitory computer-readable storage medium of claim 13, comprising instructions to:
throttle at least one load of the system as the output voltage transitions to the first output voltage; and
disable the throttle when the first output voltage has been reached.
